(19) United States
(12) Patent Application Publication
(10) Pub. No.: US 2003/0128625 A1
(43) Pub. Date: Jul. 10, 2003

(54) Process for improving the production rate of compounding mixers

(76) Inventor: Roy W. Cabler JR., Wimberley, TX (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/337,126

(22) Filed: Jan. 6, 2003

Related U.S. Application Data
(60) Provisional application No. 60/346,574, filed on Jan. 7, 2002.

(51) Int. Cl. B29B 7/46

(52) U.S. Cl. 366/84

(57) ABSTRACT

A compounding mixer for mixing plastic materials includes a mixer body with two partially cylindrical mixing chambers. The mixing chambers are in communication with a mixer inlet and a mixer outlet. Each mixing chamber also has a rotor for mixing materials within each chamber. A modular mixer liner is installed within each mixing chamber, where each mixer liner has a groove geometry for interacting with the plastic materials processed within the mixer. In a particular embodiment the groove geometry of the modular mixer liners is formed to resist circular motion of the plastic materials processed within the mixer and encourage linear motion of the plastic materials through the mixer.

### CROSS REFERENCE TO RELATED APPLICATION

This application claims priority to U.S. Provisional Patent Application Serial No. 60/392,400, filed Jan. 7, 2002, and entitled “A Process for Improving the Production Rate of Plastic Compounding Machines.”

### TECHNICAL FIELD OF THE INVENTION

The present invention relates in general to process machinery and more specifically to a process for improving the production rate of plastic compounding machinery.

### BACKGROUND OF THE INVENTION

Melt compounding of many plastics such as poyolefins plastics consists of feeding the plastic, usually in pellet form, into a mixer and melting it by heat, friction or shearing or a combination thereof. Heating may be achieved by the input of thermal energy from a medium of a higher temperature such a steam, electric heaters, hot oil, or another suitable source. Friction creates higher temperature by converting mechanical energy to thermal energy by interaction between material at different velocities. Shearing of plastic is often primarily a frictional method of thermal energy generation. Often, during the preliminary non-molten stages of mixing, various additives including variations in the plastic feed become blended or dry mixed. After the plastic melts, a much more intimate and dispersive mixing takes place.

Often, due to changes in adhesive/frictional properties of the mass versus plastic alone, forward conveying through the mixer or motion other than circular motion within the mixer is substantially reduced. This reduction is typically most pronounced prior to melting/fluxing of the plastic components and results in increased compounding cycle times if a batch mixer is used, or decreased throughput in a continuous mixer. Such an increase in compounding cycle times or decreased throughput indicates that the mixer drive system's total energy capability is only partially utilized. To operate efficiently, mixers require a combination of friction and/or adhesion between the rotating mixing elements, the materials to be mixed and the mixer containment walls. Most mixers employ a rotating element or elements. Some mixers include rotating elements with some reciprocal linear movement and (excepting two roll mills) a barrel or multi barrel containment system.

Compounding systems typically contain a number of systems or units. For example, a compounding system may include a mixer feed system, a mixer system, an extruder pelletizer system, a dryer or dewater system, and various packaging and infrastructure systems. Mixer systems typically make up a very large economic portion of a compounding system and the other units are typically sized to support a multiple of the maximum throughput of the mixer unit.

If all units within the compounding system are operating at sufficient capacity to fully support the maximum capacity of the mixer system (and the mixer is operating at maximum capacity), then the capital investment made in the compounding system is being fully utilized. However, if the mixer system is not able to operate at maximum throughput, a significant portion of the capital investment in the mixer system, as well as the other units within the compounding system, are significantly under utilized.

### SUMMARY OF THE INVENTION

Therefore, a need has arisen for a system and method for increasing the throughput of compounding mixers.

A further need has arisen for a system and method for selectively controlling the frictional interaction of feed materials in a compounding mixer.

In accordance with the teachings of the present invention, disadvantages and problems associated with throughput limitations of compounding mixers have been substantially reduced or eliminated. The present invention discloses an arrangement of machinery, including grooved modular mixer liners, to significantly improve the production throughput of internal plastic compounding systems.

In one aspect, a compounding mixer for mixing plastic materials includes a mixer body having at least one mixing chamber formed therein that is in communication with a mixer inlet and a mixer outlet. The at least one mixing chamber also has a rotor associated therewith that is operable to mix materials within the mixing chamber. At least one modular mixer liner is selectively disposed within the mixing chamber and each modular mixer liner has a plurality of grooves formed to interact with the materials processed within the mixer.

In another aspect, a modular mixer liner for controlling frictional interaction of materials mixed within a compounding mixer is disclosed. The mixer liner includes a liner body sized to be disposed within a mixing chamber. The liner body has an outer surface and an inner surface. The inner surface has a plurality of grooves formed therein to frictionally interact with materials processed within the mixer. More particularly, the modular mixer liner is sized to be disposed within the mixing chamber of a non-intermeshing continuous internal mixer.

In yet another aspect, a method for improving the production rate of compounding mixers is described, including providing at least one modular mixer liner with a plurality of grooves formed on the inner surface thereof and disposing the modular mixer liner within a mixing chamber of a compounding mixer. In a particular aspect, the modular mixer liner may be removed and replaced with a replacement modular mixer liner having a groove geometry designed to increase frictional interaction of the materials processed within the mixer.

The present invention discloses a number of important technical advantages. One important technical advantage is utilizing a grooved modular mixer liner that advantageously increases the frictional interaction of materials processed within the mixer. Another important technical advantage is providing mixer liners that are modular and may be removed and replaced with replacement modular mixer liners with different groove geometries in order to obtain a desired level of frictional interaction within the mixer.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of a drive system of a mixer system;

FIG. 2 is a diagram showing the units of a compounding system;

FIG. 3A shows an end view of modular mixer liners for use with a twin rotor, non-intermeshing continuous internal mixer feed section according to teachings of the present invention;

FIG. 3B shows an end view of modular mixer liners disposed within the mixing section of a twin rotor, non-intermeshing continuous internal mixer feed section according to teachings of the present invention;

FIG. 4 is a cut away view of a portion of a modular mixer liner with notched grooves;

FIG. 5 shows a cut away view of a portion of a modular mixer liner with notched grooves;

FIG. 6 shows a cut away view of a portion of a modular mixer liner with rounded grooves;

FIG. 7A shows a side view of a compounding mixer having multiple modular mixer liners;

FIG. 7B shows a side view of a compounding mixer having multiple modular mixer liners of varying sizes; and

FIG. 8 shows a top view of a compounding mixer having multiple modular mixer liners with varying groove geometries.

### DETAILED DESCRIPTION OF THE INVENTION

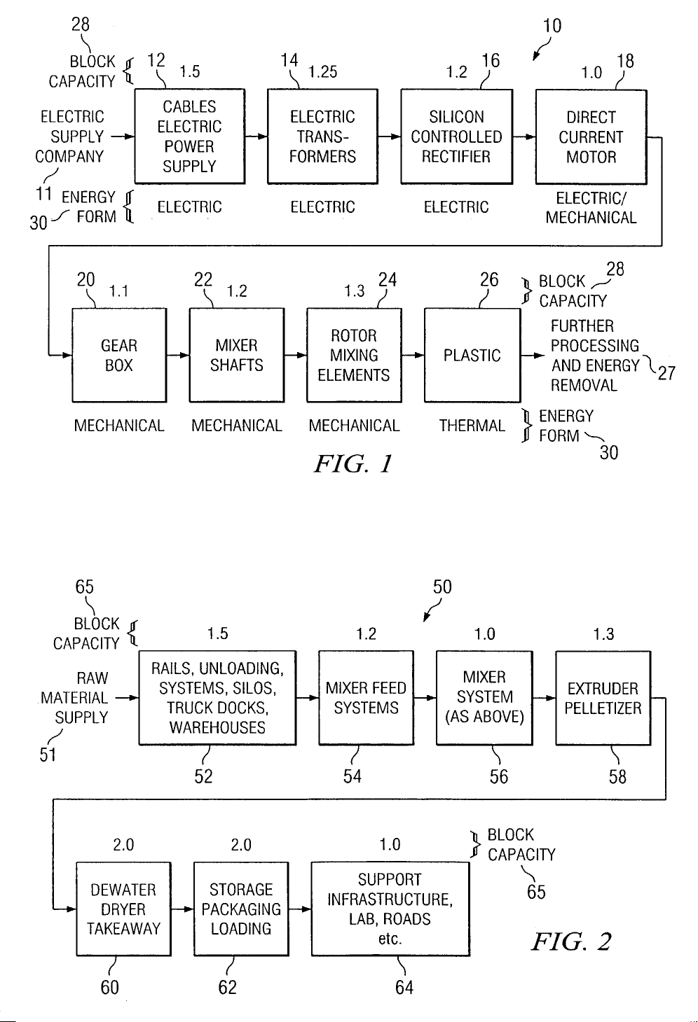

Preferred embodiments of the present invention and their advantages may be better understood by reference to the example systems and block diagrams illustrated in FIGS. 1 through 8.

Now referring to FIG. 1, a block diagram of the units of a drive system 10 of a twin rotor, non-intermeshing continuous internal mixer are shown along with the corresponding block capacity 28 and energy form 30 of each block. In the present embodiment, drive system 10 is the drive system associated with mixer system 56 as described in FIG. 1 hereunder. However, in alternative embodiments, the general principles discussed herein may apply to any suitable internal mixer.

The drive system 10 of a twin rotor, non intermeshing internal mixer includes the electrical supply system 12, transformers 14, usually a Silicon Controlled Rectifier (SCR) system 16 (a motor generator set may be used in alternative units), a D.C. motor 18 (or variable speed A.C. motor in alternative units), a gearbox 20 for speed reduction and torque multiplication and intercoupling gears between the rotor drive shafts and the internal mixer rotor shafts 22. The subsequent mixer parts that are not intrinsically part of the drive are the rotor mixing elements 24 which can be an integral part of the rotor shafts or may be removable parts.

Drive system 10 receives electrical power from electric supply 11. After processing materials through mixer 10, the processed materials are then sent for further processing 27.

The drive system as outlined above is usually designed such that all the parts are capable of transmitting all the electrical power needed upstream of main drive motor 18 (expressed as watts) and downstream of the motor in mechanical power expressed as shaft torque and RPM (horsepower in English units). Typically, drive system 10 of the mixer makes up a very large economic unit of the entire mixer.

Now referring to FIG. 2, a block diagram of the systems, which may also be referred to herein as units or blocks, of a compounding system 50 are shown with corresponding example block capacities 65. Compounding system 50 receives material from a raw materials supply 51 and includes transportation and storage systems 52, mixer feed system 54, mixer system 56, pelletizing system 58, drying and take away system 60, storage, packaging and loading system 62, and support and infrastructure system 64. Because mixer system 56 is typically the limiting system, the other units within compounding system 50 are usually sized for a multiple of the maximum (drive-system 10-limited) throughput of mixer 56. These units are also a large under utilized part of the entire compounding system 50 when throughput is reduced through mixer 56.

For exemplary purposes, compounding system 50 described in FIG. 2 requires a capital investment of approximately 8.0 million dollars. If all “blocks” in complete compounding system 50 are operating at a capacity of 1.0 (the limiting capacity of the mixer motor) then the 8.0 million dollar investment is fully utilized. If any block is below 1.0 capacity then all blocks are reduced as none can long exceed the limiting block throughput.

In one example, if feed system 54 is operating at 60% of capacity, the capacity of the compounding system is 1.2×0.6=0.72. Thus, 8.0 million×0.72=$5.76 million of the investment is being utilized, or $2.24 million of the capital investment of the compounding system is not being used.

In a second example, mixer 56 will only draw 50% of available horsepower at the maximum possible feed rate limited by mixer/compound component characteristics. If the production rate at 50% motor (horsepower) capacity is 12,000 lb./hour-then approximately 12,000 lb./hour of production is lost.

If the underperforming unit is the mixer unit 56 and its rate of throughput is half of rated throughput of mixer 56 then the whole 8 million dollar system is operating at 50% (0.5 utility) and the idle investment is 4 million dollars ($4,000,000.00). The teachings below are directed at an advantageous technical and economic solution for an underperforming mixer.

As an example for determining maximum throughput of compounding system 50, the limiting element is typically the mixer motor 18. It is the limit of mixer system 56, the most expensive system within compounding system 50 in the present embodiment. To determine this limitation, the rated horsepower of D.C. motor 18 (or kilowatts) is used. At rated horsepower output, the ampere output will be at 100% when motor 18 is at 100% of rated RPM. These conditions will yield 100% of possible mechanical output which, when applied efficiently to the mixer feed stream 54 will produce 100% of rated BTUs, resulting in maximum plastic compound production. While 100% of input electric energy is not available at the rotor shafts, a very high proportion of motor mechanical output is available. After bearing, gear, and other frictional losses, heat balances have shown this efficiency to typically be between 95-98%.

For example:

$$1. 1200 HP ( D . C . motor ) \times 2545 \frac{BTU}{HP hr} = 3 \text{,} 054 \text{,} 000 \frac{BTUs}{hr}$$

$$2. Using 250 \frac{BTU}{Lb} to take L . D . PE from 80 ° F . to 320 ° F . \\ \frac{3 \text{,} 054 \text{,} 000 \frac{BTU}{Hr}}{250 \frac{BTU}{Lb}} = 12 \text{,} 221 Lb . \text{/} Hr$$

The loss of heat to mixer 56 from the plastic (in the absence of excessive water cooling) is typically regained by thermal heating of fresh feed into the mixer thus recycling this waste heat. The balance of the heat in the plastic, with some small ambient losses, will usually end up vaporizing water in the dryer 60 and cooling tower.

As an example of a mixer with inefficient throughput: (Assuming a 1200 HP mixer 56 used to mix a compound of 30% Low Density Polyethylene (L.D.Pe) and 70% talc.

$$\begin{matrix}30 \% LDPE \frac{250 BTU}{Lb PE} \times 0.3 = & \frac{75 BTU}{Lb PE} \\ 70 \% Talc ( 320 ° F . - 80 ° F . ) ( 0.224 \frac{BTU}{{LbTalc }^{°} F .} = & { \frac{ 54 BTU}{LbTalc}}_{\_\_\_ \_\_\_ \_\_\_ \_\_\_ \_\_\_ \_} \\ Compound heat requirements \to & \frac{129 BTU}{Lb} \\ {\underline{3 , 054 , 000 \frac{BTU}{Hr } } }_{\_ } & \\ 129 \frac{BTU}{Lb .} = 23 , 674 \frac{Lb}{Hr} & \end{matrix}$$

Typical production rates on this compound are approximately 35% of maximum. In other exemplary embodiments, talc or other suitable materials may be combined with Linear Low Density Polyethylene or High Density Polyethylene.

In this embodiment, the problem appears to be primarily due to loss of frictional interaction of the dry mix of heavily loaded compounds with the walls of mixer 56, starting in the feed hopper 54 and continuing through to and, in some cases, even after complete fluxing of the plastic. Without the frictional engagement of the materials with the walls the materials tend to rotate circularly with reduced frictional energy absorption.

The following embodiments describe solutions for the problem of loss of frictional interaction and particularly solutions with respect to non-intermeshing, twin rotor compounding dry mixers. In particular, the teachings of the present invention are applicable to continuous mixers with individually “stackable” rotor configurations. That is, the rotor shafts associated with the present invention are simple mechanical shafts used to turn the various elements that are assembled in various configurations on them.

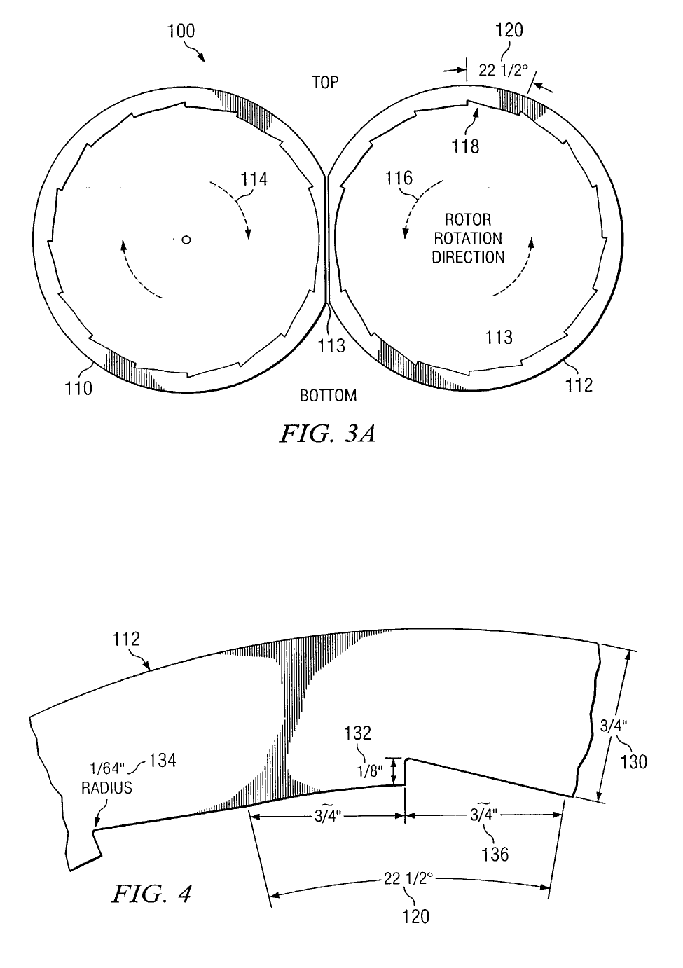

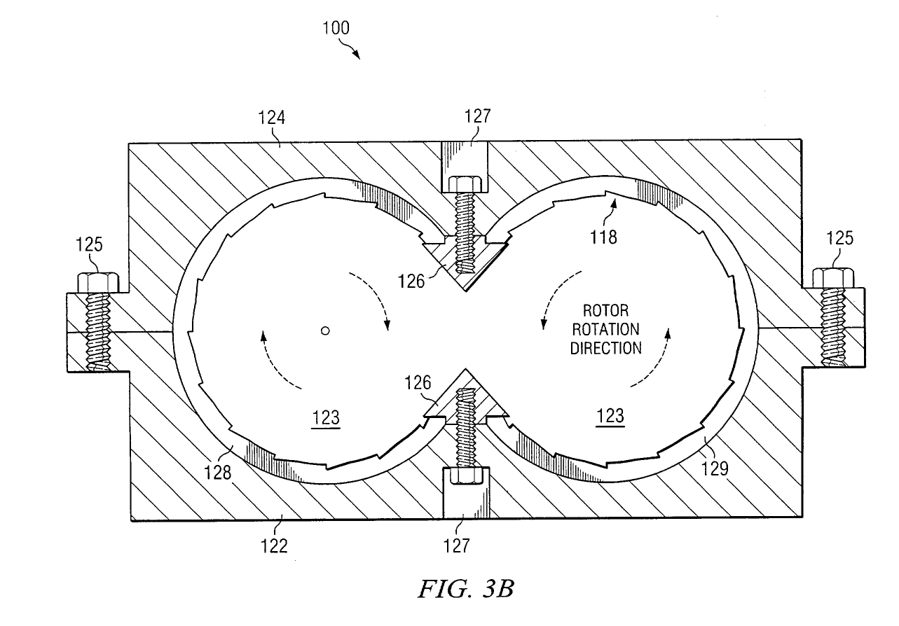

Now referring to FIG. 3A, an end view of modular mixer liner 100 for use with a compounding mixer is shown. First modular mixer liner 110 and second modular mixer liner 112 are cylindrical or barrel type liners sized to be disposed within the feed section of a mixer such as a non-intermeshing, twin rotor compounding mixer. Modular mixer liners 110 and 112 each have an exterior surface 124 and an interior surface 122. Modular mixer liners 110 and 112 each have a plurality of grooves 118 formed on the respective interior surfaces 122 thereof. In the present embodiment, notched grooves 118 of each modular mixer liner 110 and 112 are formed to oppose the rotor rotation direction 114 and 116 of each mixing chamber 126 and 128, respectively. Mixer liners 110 and 112 each have a flat portion 113 on the exterior surface thereof that preferably restrain liners 110 and 112 from turning during operation.

In the alternative embodiment, different groove patterns, types and groove geometries may be utilized to achieve a desired amount of frictional mixing in chambers 126 and 128. Modular mixer liners 110 and 112 and the grooves 110 formed thereon are designed to create large multiples of frictional/mechanical interaction between liners 110, 112 and the rotating dry feed materials driven by the rotors (not expressly shown). This increased frictional interaction advantageously results in greater linear motion of the mix through the mixer, larger shear forces between the rotor elements and mixer walls, and more mechanical energy conversion to thermal energy within the mixer.

Now referring to FIG. 3B, a mixing section of a non-intermeshing continuous internal mixer is shown. The mixer includes a lower body 122 and an upper body 124 secured together by fasteners 125. Lower body 122 and upper body 124 form a cavity 123 for mixing process materials. Modular mixer liners 128 and 129 are disposed within cavity 123. In the present embodiment, modular mixer liners 128 and 129 are not full cylinders but each have an opening of approximately ninety degrees. Liners 128 and 129 are preferably retained by retaining bars 126 which are secured by fasteners 127.

Now referring to FIG. 4, a cutaway view of a portion of modular mixer liner 112 is shown. In the present embodiment, modular mixer liner 112 has an inner radius of approximately nine inches and a nominal thickness 130 of approximately 0.75 inches. Modular mixer liner also includes a plurality of notched grooves 118 formed at angular intervals 120 of approximately 22.5 degrees. Each notch 118 has a notch height 132 of approximate 0.125 inches, a notch length 136 of approximately 0.75 inches, and the bottom edge of each notch has a bottom radius 134 of 0.015 inches. Bottom radius 134 acts to reduce stress risers in the modular mixer liner 112. In alternative embodiments the geometry of groove 118, including but not limited to angular interval 120, notch height 132, notch bottom radius 134, and notch length 136 may be increased or decreased to achieve increased or decreased frictional interaction of liner 112 with process materials.

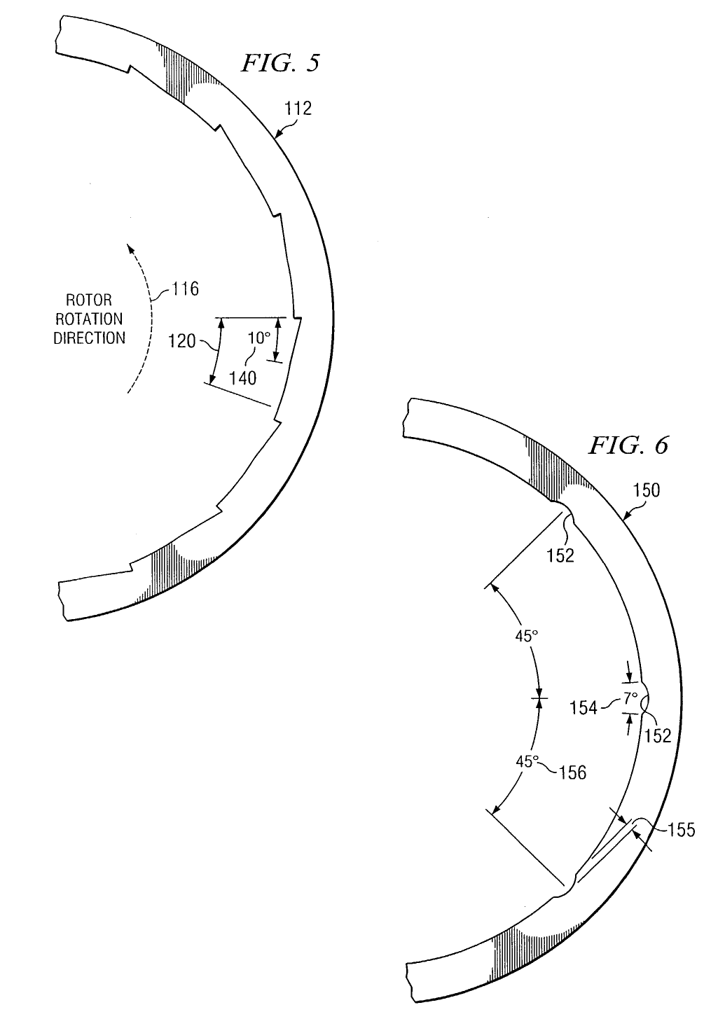

Now referring to FIG. 5, a cutaway view of modular mixer liner 112 is shown. As shown with respect to FIG. 4, mixer liner 112 has grooves 120 with a height of approximately 0.125 inches. Additionally, grooves 118 are cut axially parallel for the length of liner 112. Also in the present embodiment grooves 120 have a length of approximately 0.75 inches on a ten degree periphery 140. In alternative embodiments, grooves 118 may be cut in a spiral configuration in either a left-hand or a right-hand direction. Additionally, alternative grooves and groove patterns may incorporate various periphery angles, deeper grooves, shallow grooves, axially oriented grooves, rectangular grooves, symmetrical triangular grooves, and other suitable groove geometries. Alternative modular mixer liners may also be smooth, containing no grooves.

Now referring to FIG. 6, a cutaway view of a modular mixer liner 150 is shown. Modular mixer liner 150 has linear grooves 152 made of portions of a 0.75 inch outer diameter circular segments originating from a circle having a radius of 2 11/16 inches. The resulting groove 152 of the present embodiment has an arc 154 of approximately seven degrees and a depth 155 of approximately 0.125 inches. Grooves 152 are set at angular intervals 156 of approximately forty-five degrees. Grooves 152 are non-directional (in comparison with grooves 120 as shown in FIG. 3) and create minimum restrictions. Grooves 152 also create minimal serious stress risers in liner 150. In alternative embodiments, the size of arc 154, groove depth 152 angular intervals 156 may be varied to achieve a desired level of frictional interaction.

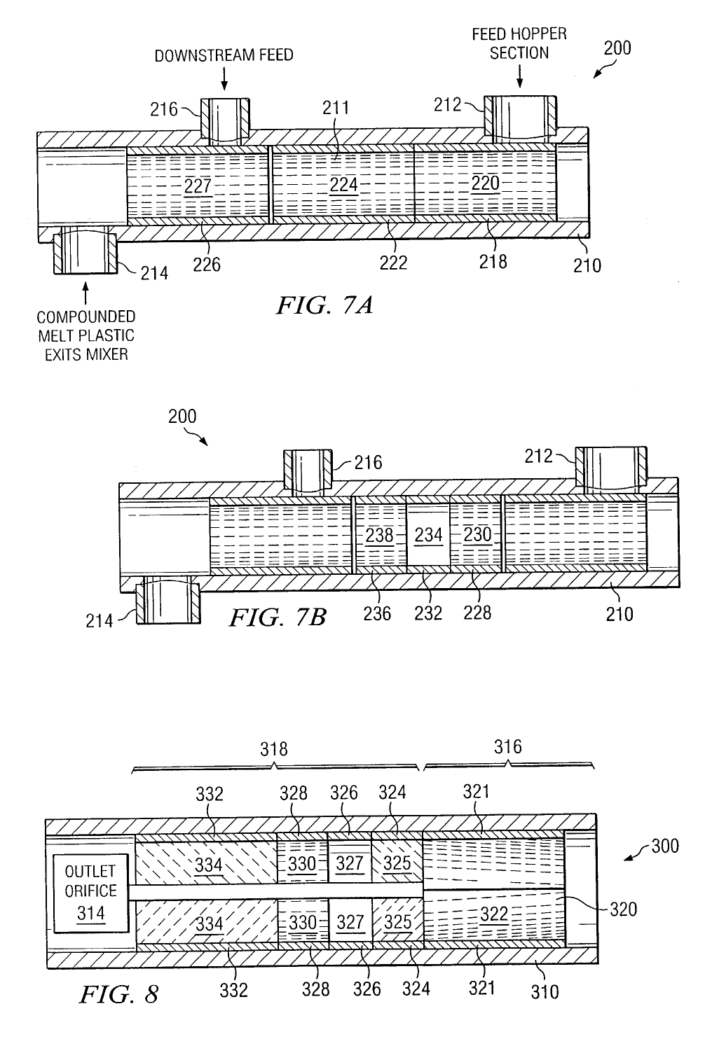

Now referring to FIGS. 7A and 7B, side views of a compounding system 200 including multiple modular mixer liners are shown. Compounding mixer 200 includes a mixer body 210 having a mixer inlet 212 preferably connected to a feed hopper and a mixer outlet 214. In the present embodiment compounding mixer also includes downstream feed inlet 216 that allows feed materials, particularly non-melting or friction reducing ingredients, to be added to the mixer after mixer inlet 212. Mixer body 210 preferably forms mixing chamber 211 for processing materials.

Modular mixer liners 218, 222, and 226 are disposed within mixing chamber 211. Each mixer liner 218, 222, and 226 has a groove pattern 220, 224, and 227, respectively. Groove patterns 220, 224, and 227 represent axially linear grooves. In this particular embodiment, downstream feed inlet 216 allows feed materials to be added to the mixer downstream of most of the mixer liners.

FIG. 7B shows modular mixer liner 222 removed and replaced by three smaller mixer liners 228, 232, and 236 each having respective groove geometries 220, 234, and 238. In the embodiment shown in FIG. 7B, groove pattern 234 shows a smooth modular mixer liner with no grooves, operable to decrease the frictional interaction within mixing chamber 211.

Now referring to FIG. 8, an overhead view of compounding mixer 300 is shown. Compounding mixer 300 includes a mixer body 310 having mixer inlet (not expressly shown) and a mixer outlet 314. Mixer body 310 includes feed section 316 and mixing section 318. Feed section 316 includes feed throat 320 which comprises two generally cylindrical feed mixing chambers (as shown in FIG. 3A). Feed throat 320 feeds into mixing section 318 (as shown in FIG. 3B).

In the present embodiment, feed throat 320 includes a feed throat liner 321 having groove geometry 322. Additionally, each mixing chamber 316 and 318 includes modular mixer liners 324, 326, 328, and 332 each having associated groove geometries 325, 327, 330, and 334, respectively. As shown, to accomplish the desired interaction of materials processed within mixer 300, modular mixer liners of various sizes and groove geometries may be operatively installed within mixer 300.

To accomplish the desired interaction of the materials with the walls of mixer 300, grooves in the modular mixer liners cause the compound mix to resist circular motion, creating more friction and thus thermal energy expressed as higher temperature of the compound. Further, the groove designs will cause the redirection of material from circular motion to linear motion both forward and backward in the mixer. A combination or stack of grooved, smooth, and grooved liners can be assembled in combination with the rotor elements stack on the rotor shafts. The correct combination of grooved liners with combinations of deeper grooves, shallow grooves, straight axially oriented grooves, spirally cut grooves, both left and right hand twist etc., along with the effective rotor stack geometry, may be experimentally determined for each family of compounds and each compounding mixer. An optimized combination of liner and rotor geometry can be arrived at for a single setup for each machine.

In the present embodiment, liners may be constructed of alloys such a 4140, 4340 or other suitable metal alloys. The alloys may heat treated to a harness of approximately 43 Rockwell C (±2 units) for good shock resistance. In some embodiments, this treatment may be followed by hard chrome plating on the inside and end surfaces to a thickness in the range of 0.002 to 0.005 inches. Where shock resistance is not a significant requirement, alloys that may be hardened after machining to have a hardness between 55-65 Rockwell C may be used and obviate the need for chrome plating.

To further make use of this system, whenever possible, downstream feed of a significant proportion of the non-melting ingredients and/or friction reducing ingredients should be accomplished. The reasons for downstream feed include: increased adhesion of the initial feed compound due to a higher percentage of the more “sticky” components, usually one or more of the plastic ingredients considerably increases the production rate and the addition of more dry ingredients downstream after the mass in the machine is molten both decreases liner wear and improves mixing/compounding efficiency. To use downstream feed the mixer body is preferably designed for this improvement and various mixer dams, rotor feed sections and feed system alterations must be accomplished.

Depending on machine size, rotor speed, compound formula, geometry comprises for universality of application, and many other mixer design needs, the grooves can be varied in number, size, shape, depth, angularity, degree of helix and other details to meet needs of compounding efficiency.

Although the disclosed embodiment has been described in detail, it should be understood that various changes, alterations, and substitutions can be made without departing from their spirit or scope.

What is claimed is:

1. A compounding mixer for mixing plastic materials comprising:
a mixer body having at least one mixing chamber formed therein, the mixing chamber in communication with a mixer inlet and a mixer outlet;
the at least one mixing chamber having a rotor associated therewith, operable to mix materials within the mixing chamber;
at least one modular mixer liner selectively disposed within the mixing chamber, each modular mixer liner having a plurality of grooves formed to interact with the materials processed within the mixer.

2. The mixer of claim 1 wherein the mixer comprises a continuous internal mixer.

3. The mixer of claim 2 wherein the mixer comprises a stackable non-intermeshing-type mixer.

4. The mixer of claim 1 wherein the modular mixer liner grooves further comprise linear grooves substantially parallel to the longitudinal axis of the mixing chamber.

5. The mixer of claim 1 wherein the modular mixer liner grooves further comprise grooves having a spiral configuration.

6. The mixer of claim 1 wherein the modular mixer liner grooves comprise a plurality of notched grooves operable to restrict rotation of the plastic materials processed within the mixer.

7. The mixer of claim 1 wherein the modular mixer liner grooves comprise rounded grooves.

8. The mixer of claim 1 further comprising a plurality of modular mixer liners disposed within the mixing chamber.

9. The mixer of claim 1 further comprising the modular mixer liner operable to be selectively removed and replaced with a replacement mixer liner having a groove geometry formed to selectively increase frictional interaction of plastic materials processed within the mixer.

10. The mixer of claim 1 further comprising the modular mixer liner operable to be selectively removed and replaced with a replacement mixer liner having a groove geometry formed to selectively decrease frictional interaction of plastic materials processed within the mixer.

11. The mixer of claim 1 further comprising the plurality of grooves operable to resist circular motion of the plastic materials processed within the mixer and encourage linear motion of the plastic materials.

12. The mixer of claim 1 further comprising at least one mixing chamber having at least two modular mixer liners disposed therein wherein each modular mixer liner comprises a distinct groove pattern.

13. The mixer of claim 1 further comprising a feed throat chamber formed within the mixer body, the feed throat chamber comprising two substantially cylindrical feed mixing chambers in communication with the mixer inlet and the mixing chamber.

14. The mixer of claim 13 further comprising at least one feed throat chamber modular mixer liner sized to be selectively disposed within the feed throat and having a plurality of grooves formed to increase the frictional interaction of the plastic materials processed within the feed throat.

15. The mixer of claim 1 wherein the mixer body further comprising a downstream feed inlet for introducing process materials into the mixer downstream of the mixer inlet.

16. A modular mixer liner for controlling frictional interaction of materials mixed within a compounding mixer comprising:
a liner body sized to be disposed within a mixing chamber, the liner body having an outer surface and an inner surface; and
the inner surface having a plurality of grooves formed therein to frictionally interact with materials processed within the mixer.

17. The modular mixer liner of claim 16 further comprising the liner body sized to be disposed within the mixing chamber of a stackable, non-intermeshing continuous internal mixer.

18. The modular mixer liner of claim 16 wherein the plurality of grooves further comprise linear grooves substantially parallel to the longitudinal axis of the modular mixer liner.

19. The modular mixer liner of claim 16 wherein the grooves comprise a spiral configuration.

20. The modular mixer of claim 16 wherein the grooves comprise a plurality of notched grooves.

21. The modular mixer of claim 16 wherein the grooves comprise rounded grooves.

22. The modular mixer of claim 16 further comprising the plurality of grooves operable to resist circular motion of feed materials processed in the modular mixer liner and encourage linear motion through the length of the liner.

23. The modular mixer liner of claim 16 further comprising the liner body having a generally cylindrical shape with an approximately ninety degree portion removed.

24. A method for improving the production rate of stackable non-intermeshing compounding mixers comprising:
providing at least one modular mixer liner having a plurality of grooves formed on the inner surface thereof; and
disposing the modular mixer liner within a mixing chamber of a compounding mixer.

25. The method of claim 24 further comprising:
providing a plurality of modular mixer liners having a plurality of groove geometries; and
disposing at least two modular mixer liners within the mixing chamber.

26. The method of claim 24 wherein providing the at least one modular mixer liner further comprises providing a modular mixer liner having a plurality of linear grooves formed substantially parallel to the longitudinal axis of the modular mixer liner.

27. The method of claim 24 wherein providing the at least one modular mixer liner further comprises providing a modular mixer liner having a plurality of grooves formed in a spiral configuration.

28. The method of claim 24 wherein providing the at least one modular mixer liner comprises providing a modular mixer liner having a plurality of notched grooves operable to restrict rotation of feed materials processed through the modular mixer liner.

29. The method of claim 24 wherein providing the at least one modular mixer liner further comprises providing at least one modular mixer liner having rounded grooves.

30. The method of claim 24 further comprising:
removing the modular mixer liner disposed within the cylindrical mixing chamber; and
disposing a replacement modular mixer liner having a groove geometry selected to increase frictional interaction of the materials processed within the mixer.

31. The method of claim 24 further comprising:
removing the modular mixer liner disposed within the cylindrical mixing chamber; and
disposing a replacement modular mixer liner having a groove geometry selected to decrease frictional interaction of the materials processed within the mixer.

32. The method of claim 24 further comprising:
introducing feed materials into the mixer through a mixer inlet, the mixer inlet in communication with the mixing chamber; and
introducing downstream material through a downstream feed inlet in communication with the mixing chamber in a position downstream from the mixer inlet.

33. The method of claim 32 wherein the downstream feed material comprises a non-melting ingredient.

34. The method of claim 32 wherein the downstream feed material comprises a friction reducing ingredient.
